(19) United States
(12) Patent Application Publication
(10) Pub. No.: US 2025/0074050 A1
(43) Pub. Date: Mar. 6, 2025

(54) LIQUID EJECTING HEAD AND LIQUID EJECTING APPARATUS

(71) Applicant: SEIKO EPSON CORPORATION, Tokyo (JP)

(72) Inventor: Haruki KOBAYASHI, MATSUMOTO-SHI (JP)

(21) Appl. No.: 18/818,725

(22) Filed: Aug. 29, 2024

(30) Foreign Application Priority Data
Sep. 1, 2023 (JP) 2023-142050

(51) Int. Cl. B41J 2/14; B41J 2/175

(52) U.S. Cl. CPC B41J 2/14; B41J 2/175

(57) ABSTRACT

A liquid ejecting head includes nozzles and a feed channel through which an inlet communicates with an outlet. The feed channel is provided with a stirrer including a first-rib and a second-rib facing each other. The stirrer in a cross section perpendicular to a direction in which the stirrer extends includes a first-region where the first-rib is disposed and a second-region where the second-rib is disposed. The first-rib has a first-guide face by which a flow of the liquid in the first-region is guided into the second-region. The second-rib has a second-guide face by which a flow of the liquid in the second-region is guided into the first-region. A first-tip of the first-guide face and a second-tip of the second-guide face intersect each other when viewed in a direction in which the first-region and the second-region are aligned.

The present application is based on, and claims priority from JP Application Serial Number 2023-142050, filed Sep. 1, 2023, the disclosure of which is hereby incorporated by reference herein in its entirety.

### BACKGROUND

### 1. Technical Field

The disclosure relates to a liquid ejecting head and a liquid ejecting apparatus.

### 2. Related Art

Some proposed liquid ejecting apparatuses include liquid ejecting heads from which liquid (e.g., ink) is ejected toward a medium (e.g., printing paper).

The liquid ejecting head described in JP-A-2015-174384 includes multiple nozzles for ejecting liquid and channels for feeding liquid into the nozzles.

If liquid that has yet to be ejected from the nozzles remains for a long period of time, sedimentation of colorants, such as pigments or dyes, in the liquid may occur in the channels.

### SUMMARY

According to an aspect of the present disclosure, a liquid ejecting head includes a plurality of nozzles and a feed channel. Liquid is ejected from the plurality of nozzles. Through the feed channel, at least one inlet for introducing the liquid communicates with at least one outlet for feeding the liquid into the plurality of nozzles. The feed channel is provided with at least one stirrer including at least one first rib and at least one second rib facing each other. The at least one stirrer in a cross section perpendicular to a direction in which the at least one stirrer extends includes a first region in which the at least one first rib is disposed and a second region in which the at least one second rib is disposed. The at least one first rib has a first guide face by which a flow of the liquid in the first region is guided into the second region. The at least one second rib has a second guide face by which a flow of the liquid in the second region is guided into the first region. A first tip of the first guide face and a second tip of the second guide face intersect each other when viewed in a direction in which the first region and the second region are aligned.

### BRIEF DESCRIPTION OF THE DRAWINGS

FIG. 1 is a schematic diagram of a liquid ejecting apparatus according to a first embodiment.

FIG. 2 is an exploded perspective view of a head unit illustrated in FIG. 1.

FIG. 3 is a sectional view of the head unit illustrated in FIG. 2.

FIG. 4 illustrates part of the head unit in FIG. 2 viewed in a Z2 direction.

FIG. 5 is a sectional view of a head chip illustrated in FIG. 2.

FIG. 6 illustrates a first channel member in FIG. 3 viewed in the Z1 direction.

FIG. 7 illustrates the first channel member in FIG. 3 viewed in the Z2 direction.

FIG. 8 illustrates a second channel member in FIG. 3 viewed in the Z1 direction.

FIG. 9 illustrates the second channel member in FIG. 3 viewed in the Z2 direction.

FIG. 10 is a sectional view of a channel member illustrated in FIG. 2.

FIG. 11 is a sectional view of the channel member illustrated in FIG. 2.

FIG. 12 is a plan view of a stirrer illustrated in FIG. 11.

FIG. 13 is a sectional view taken along line XIII-XIII in FIG. 12.

FIG. 14 is a plan view of first ribs illustrated in FIG. 12.

FIG. 15 is a plan view of second ribs illustrated in FIG. 12.

FIG. 16 is a sectional view taken along line XVI-XVI in FIG. 12.

FIG. 17 is a sectional view taken along line XVII-XVII in FIG. 12.

FIG. 18 is a sectional view taken along line XVIII-XVIII in FIG. 12.

FIG. 19 is an explanatory diagram illustrating the arrangement of stirrers illustrated in FIG. 12.

FIG. 20 is an explanatory diagram illustrating the flow of ink in a channel of a channel member in Comparative Example.

FIG. 21 is an explanatory diagram illustrating the flow of ink in the channel of the channel member in the first embodiment.

FIG. 22 is an explanatory diagram illustrating the flow of ink along first ribs and second ribs of the stirrer in FIG. 11.

FIG. 23 is a plan view of a stirrer in a second embodiment.

FIG. 24 is a plan view of first ribs illustrated in FIG. 23.

FIG. 25 is a plan view of second ribs illustrated in FIG. 23.

FIG. 26 is an explanatory diagram illustrating the flow of ink along the first ribs and the second ribs of the stirrer in FIG. 23.

FIG. 27 is a plan view of a stirrer in an example of variations.

FIG. 28 illustrates the arrangement of stirrers in an example of variations.

### DESCRIPTION OF EMBODIMENTS

Preferred embodiments of the present disclosure are described in detail below with reference to the accompanying drawings. The dimensions of constituent elements in the drawings do not necessarily correspond to their actual dimensions, and each element is not necessarily drawn to scale and may be schematically illustrated for ease of understanding. Unless otherwise noted, the following description should not be construed as limiting the scope of the present disclosure.

### 1. First Embodiment

### 1A. Liquid Ejecting Apparatus 100

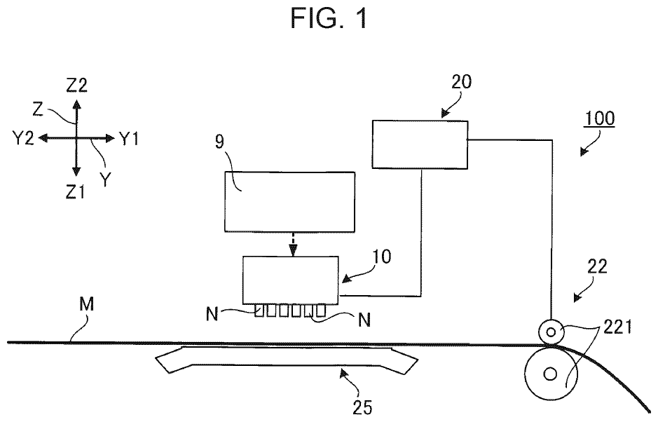

FIG. 1 is a schematic diagram of a liquid ejecting apparatus 100 according to a first embodiment. Mutually orthogonal axes respectively denoted by X, Y, and Z may be hereinafter used for convenience of illustration. One of the two directions on the X-axis is denoted by X1, and the direction opposite to the X1 direction is denoted by X2. Likewise, one of the two directions on the Y-axis is denoted by Y1, and the direction opposite to the Y1 direction is denoted by Y2. One of the two directions on the Z-axis is denoted by Z1, and the direction opposite to the Z1 direction is denoted by Z2. In the present embodiment, the Z1 direction is the direction of gravity. However, the direction of gravity may be a direction intersecting the Z1 direction.

The liquid ejecting apparatus 100 in FIG. 1 is an ink jet printing apparatus that ejects ink onto a medium M. The ink is an example of liquid. Typically, the medium M is printing paper; however, any kind of printable material, such as a resin film or fabric, may be used as the medium M.

The liquid ejecting apparatus 100 includes a liquid reservoir 9, a control unit 20, a medium transport mechanism 22, and a head unit 10. Liquid is stored in the liquid reservoir 9. For example, a cartridge removably attached to the head unit 10, a sac-like ink pack made of flexible film, or a refillable ink tank is used as the liquid reservoir 9.

The control unit 20 includes one or more processing circuits, such as central processing units (CPUs) or field programmable gate arrays (FPGAs), and one or more storage circuits, such as semiconductor memory, to perform centralized control of elements constituting the liquid ejecting apparatus 100.

The medium transport mechanism 22 under the control of the control unit 20 transports the medium M along the Y-axis. The medium transport mechanism 22 includes transport rollers 221 for transport of the medium M. The liquid ejecting apparatus 100 may, for example, include a movement mechanism that causes the head unit 10 to reciprocate along the X-axis.

The head unit 10 includes liquid ejecting heads 1. The liquid ejecting heads 1 are each controlled by the control unit 20 such that ink fed from the liquid reservoir 9 is ejected from nozzles N onto the medium M. As the medium M is transported by the medium transport mechanism 22, the liquid ejecting heads 1 each eject ink onto the medium M such that an image is formed on the surface of the medium M.

The liquid ejecting apparatus 100 includes the liquid ejecting heads 1 and the liquid reservoir 9 in which ink that is to be fed into the liquid ejecting heads 1 is stored. The liquid ejecting heads 1 have a configuration in which ink can be stirred in an efficient manner even if sedimentation of ink components such as colorants have occurred. This feature will be described later. The liquid ejecting apparatus 100 can thus reduce the possibility of deterioration in image quality.

### 1B. Head Unit 10

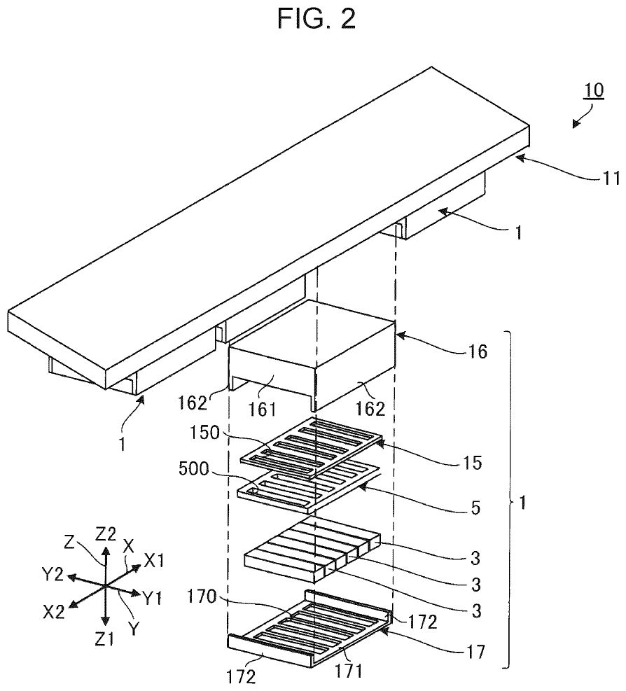

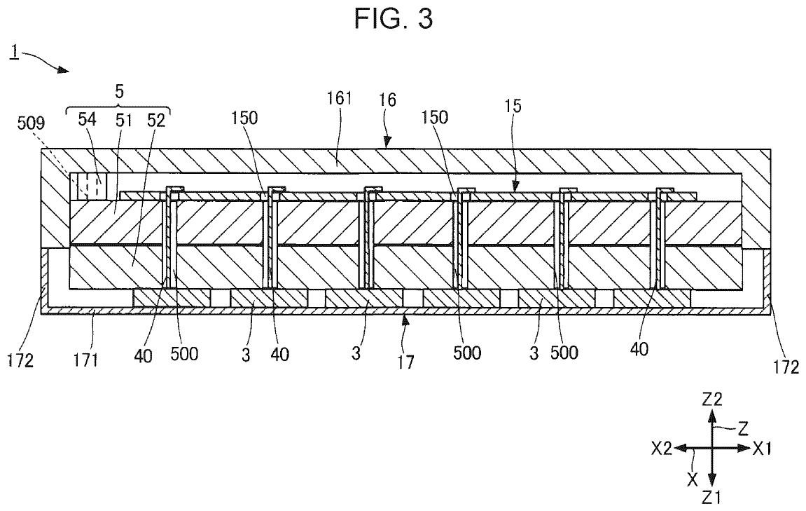

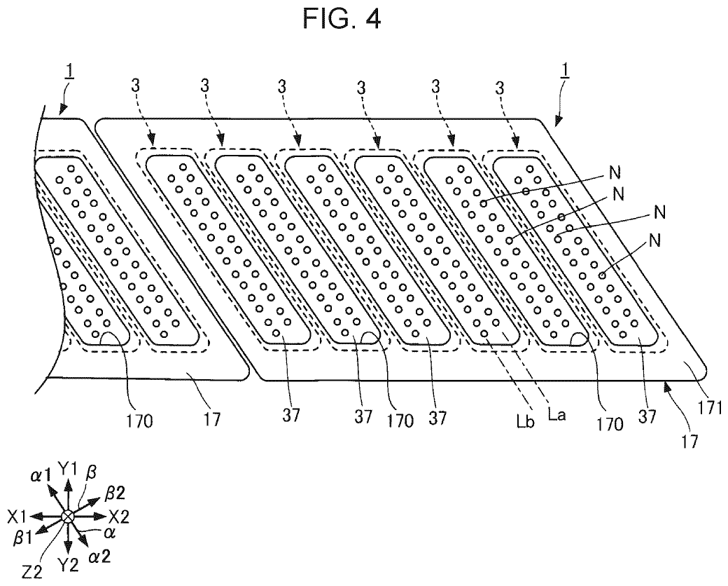

FIG. 2 is an exploded perspective view of the head unit 10 illustrated in FIG. 1. FIG. 3 is a sectional view of the head unit 10 illustrated in FIG. 2. FIG. 4 illustrates part of the head unit 10 in FIG. 2 viewed in the Z2 direction. The term “in plan view” is herein used when a constituent element of interest is viewed in the direction of the Z-axis.

Referring to FIG. 2, the head unit 10 includes a unit base 11 and the liquid ejecting heads 1. The unit base 11 has a longitudinal shape extending along the X-axis. The unit base 11 is a member for fixing the liquid ejecting heads 1. The liquid ejecting heads 1 are arranged along the X-axis. Although four head units 10 are illustrated in FIG. 2, the unit base 11 includes at least one head unit 10. The number of head units 10 may be 2, 3, 5 or more.

The liquid ejecting heads 1 each include head chips 3, a channel member 5, a relay substrate 15, a holding member 16, and a fixing plate 17.

The head chips 3 of each of the liquid ejecting heads 1 are arranged along the X-axis. The head chips 3 each include more than one nozzle N, from which ink is ejected. Although the liquid ejecting heads 1 illustrated in FIG. 2 each include six head chips 3, the liquid ejecting heads 1 each include at least one head chip 3. The number of head chips 3 in each liquid ejecting head 1 may be not more than 5 or may be 7 or more.

The channel member 5 is disposed on the Z2 side with respect to the head chips 3 and is joined to the head chips 3. The channel member 5 has a liquid channel that allows ink to flow into the head chips 3. The liquid channel communicates with the channels in the head chips 3. The channel member 5 has wiring holes 500, each of which is provided for the corresponding one of the head chips 3. The wiring holes 500 are located at intervals along the X-axis. Each of the wiring holes 500 is a through-hole provided in the channel member 5. The head chips 3 include circuit boards 40, each of which is inserted into the corresponding one of the wiring holes 500. Each circuit board 40 is provided with a drive circuit that drives the corresponding head chip 3.

As illustrated in FIG. 3, the channel member 5 includes a first channel member 51, a second channel member 52 stacked in the Z2 direction, and two projections 54. The first channel member 51 and the second channel member 52 are stacked, with the second channel member 52 on the Z1 side of the first channel member 51. The two projections 54 are joined to a surface on the Z2 side of the first channel member 51. The two projections 54 are disposed on a diagonal of the first channel member 51, which is substantially rectangular in plan view. The projections 54 each have a hole 509, which serves as a flow path. Those mentioned above will be described in detail later.

The relay substrate 15 is disposed on the Z2 side of the channel member 5. The relay substrate 15 has holes 150. The circuit boards 40 are inserted into the respective holes 150. The circuit boards 40 are joined to a surface on the Z2 side of the relay substrate 15. Driving signals and the like from the control unit 20 mentioned above are transmitted to the drive circuits on the circuit boards 40 through the relay substrate 15.

The holding member 16 holds the head chips 3, the channel member 5, and the relay substrate 15. As illustrated in FIG. 2, the holding member 16 includes a holding portion 161 and two legs 162. The holding portion 161 has a space, where the Z1 side of the holding portion 161 is open. The channel member 5 and the relay substrate 15 are disposed within the holding portion 161. The two legs 162 each extend in the Z1 direction from the holding portion 161. One of the two legs 162 is located on the Y1 side of the holding portion 161, and the other is located on the Y2 side of the holding portion 161. The holding member 16 has holes (not illustrated) communicating with the holes 509 of the projections 54.

As illustrated in FIGS. 2 and 3, the fixing plate 17 is a member with which the head chips 3 are fixed to the holding member 16. The fixing plate 17 includes a base 171 and two bent portions 172. The base 171 is a flat plate-like portion extending along the X-Y plane. The two bent portions 172 are formed by bending part of the base 171 in the Z2 direction. One of the two bent portions 172 is located on the X1 side of the base 171, and the other thereof is located on the X2 side of the base 171. The base 171 of the fixing plate 17 is bonded to the head chips 3. The two bent portions 172 are bonded to the legs 162 of the holding member 16.

As illustrated in FIGS. 2 and 4, the base 171 has openings 170, each of which is provided for the corresponding one of the head chips 3. The openings 170 are holes in the base 171. The openings 170 are provided so that the nozzles N of the head chips 3 are exposed at the base 171. As illustrated in FIG. 4, the nozzles N of each of the head chips 3 are aligned in two rows, which are hereinafter referred to as a nozzle row La and a nozzle row Lb. The nozzles N in each row are spaced apart from each other and are aligned along an α-axis, which intersects the X-axis and Y-axis. One of the two directions on the α-axis is denoted by α1, and the direction opposite to the al direction is denoted by α2. A β-axis is orthogonal to the α-axis. One of the two directions on the β-axis is denoted by β1, and the direction opposite to the β1 direction is denoted by β2.

### 1C. Head Chips

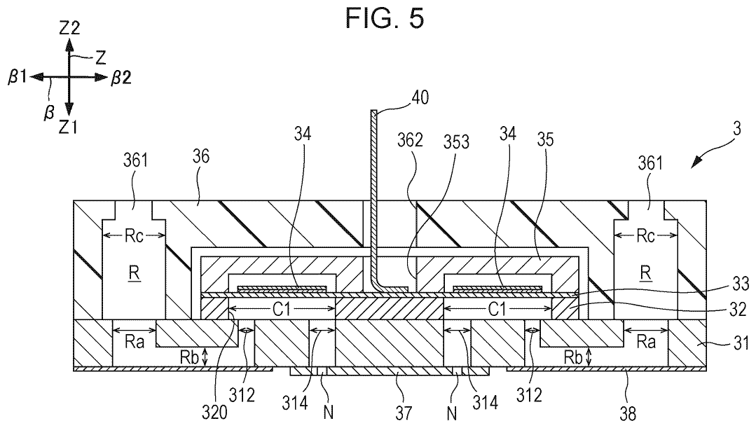

FIG. 5 is a sectional view of one of the head chips 3 illustrated in FIG. 2. The Z-axis extends in the direction of ink ejected from the head chip 3. In each head chip 3, elements provided for the nozzles N in the nozzle row La and elements provided for the nozzles N in the nozzle row Lb are disposed substantially symmetrically with respect to a plane. The head chip 3 is described below with a focus on the elements provided for one of the two rows, and description of the elements provided for the other thereof will be omitted where appropriate. The head chip 3 illustrated in FIG. 5 is provided as an example. The structure of the head chip 3 is not limited to the one illustrated in FIG. 5 as long as ink can be ejected from the head chip 3.

As illustrated in FIG. 5, the head chip 3 includes a communicating plate 31, a pressure chamber substrate 32, a diaphragm 33, a nozzle substrate 37, a vibration absorber 38, piezoelectric elements 34, a sealing substrate 35, a case 36, and the circuit board 40. The communicating plate 31, the pressure chamber substrate 32, the diaphragm 33, the nozzle substrate 37, the vibration absorber 38, the sealing substrate 35, and the case 36 are long plate-like members extending along the α-axis. The pressure chamber substrate 32 and the case 36 are disposed on a surface on the Z2 side of the communicating plate 31. The nozzle substrate 37 and the vibration absorber 38 are disposed on a surface on the Z1 side of the communicating plate 31. For example, an adhesive may be used to fix the members to each other.

The nozzle substrate 37 is a plate-like member in which the nozzles N are provided. Each of the nozzles N is a circular through-hole from which ink is ejected. For example, a single-crystal silicon (Si) substrate is formed into the nozzle substrate 37 through the use of semiconductor manufacturing techniques, such as photolithography and etching.

The communicating plate 31 includes narrowed portions 312, communicating channels 314, a communicating space Ra, and a common channel Rb. Each narrowed portion 312 and each communicating channel 314 are through-holes extending in the Z1 direction and provided for the corresponding nozzle N. Each communicating channel 314 overlaps the corresponding nozzle N in plan view. The communicating space Ra is a cavity that is long along the α-axis. The communicating space Ra extends along the α-axis. The common channel Rb communicates with the communicating space Ra. The common channel Rb overlaps the communicating space Ra in plan view. The common channel Rb extends along the α-axis. The common channel Rb communicates with the narrowed portions 312.

The pressure chamber substrate 32 includes pressure chambers C1. Each of the pressure chambers C1 is a space located between the communicating plate 31 and the diaphragm 33 and defined by a wall surface 320 of the pressure chamber substrate 32. Each of the pressure chambers C1 is provided for the corresponding one of the nozzles N. Each of the pressure chamber C1 is a long space extending along the β-axis. The pressure chambers C1 are arranged along the α-axis. One end of each of the pressure chambers C1 in the direction of the β-axis communicates with the corresponding one of the nozzles N with the communicating channel 314 located therebetween. The other end of each of the pressure chambers C1 in the direction of the β-axis communicates with the corresponding one of the narrowed portions 312. Providing the communicating channels 314 and the narrowed portions 312 on the Z1 side with respect to the pressure chambers C1 enables the nozzles to be arranged densely, and the miniaturization and densification of the head chip 3 are enabled. For example, semiconductor substrates, such as single-crystal silicon substrates, are formed into the communicating plate 31 and the pressure chamber substrate 32.

The diaphragm 33, which is elastically deformable, is disposed above the pressure chambers C1. The diaphragm 33 is stacked on the pressure chamber substrate 32 and is in contact with a surface of the pressure chamber substrate 32 on the opposite side from the communicating plate 31. The thickness direction of the diaphragm 33 is parallel to the Z1 direction. The pressure chamber substrate 32 and diaphragm 33 in FIG. 5 are illustrated as separate substrates for ease of explanation, but in actuality they are layered on a single silicon substrate.

Each of the piezoelectric elements 34 is provided for the corresponding one of the pressure chambers C1 and is disposed on a surface of the diaphragm 33 on the opposite side from the pressure chambers C1. The piezoelectric elements 34 are passive elements that are long in the direction of the β-axis in plan view. The piezoelectric elements 34 are also drive elements that are driven upon receipt of driving signals from the drive circuits. Although not illustrated in detail, the piezoelectric elements 34 each include, for example, a pair of electrodes and a piezoelectric material sandwiched between the electrodes.

The case 36 defines a space in which ink to be fed into the pressure chambers C1 is stored. For example, the case 36 is made of a resin material by injection molding. The case 36 has a space Rc. The space Rc in the case 36 and the communicating space Ra in the communicating plate 31 communicate with each other. The communicating space Ra, the common channel Rb, and the space Rc constitute a common liquid chamber R, which is shared by the nozzles N. The common liquid chamber R serves as a reservoir in which ink to be fed into the pressure chambers C1 is stored. The ink stored in the common liquid chamber R flows and branches into the narrowed portions 312, and the pressure chambers C1 are fed and filled with the ink in parallel with one another.

The vibration absorber 38 is a flexible film and is a wall surface of the communicating space Ra. The vibration absorber 38 accommodates fluctuations in the pressure of ink in the common liquid chamber R. The vibration absorber 38 is, for example, a multilayer body composed of an ink-resistant resin film, a springy stainless steel (SUS) member holding the resin film, and a fixed substrate protecting the resin film and the SUS member. Providing the vibration absorber 38 enables the natural frequency of the flow paths extending from the respective nozzles N to the respective narrowed portions 312 through the respective pressure chambers C1 to be stable irrespective of which one of the nozzles N is driven.

The sealing substrate 35 is a structure that protects the piezoelectric elements 34 and provides added mechanical strength to the pressure chamber substrate 32 and the diaphragm 33. The sealing substrate 35 is fixed to the surface of the diaphragm 33 with, for example, an adhesive. The piezoelectric elements 34 are housed in recesses provided in one surface of the sealing substrate 35 facing the diaphragm 33. The circuit board 40 is inserted through a through-hole 362 in the case 36 and a through-hole 353 in the sealing substrate 35. The circuit board 40 is bonded to the surface of the diaphragm 33. The circuit board 40 is an on-board mounting component with wiring lines for electrically connecting the control unit 20 and the head chips 3. For example, the circuit board 40 is a tape carrier package (TCP) or a flexible printed circuit (FPC). Driving signals for driving the piezoelectric elements 34 and the reference voltage are provided to each of the piezoelectric elements 34 from the circuit board 40.

In the head chip 3, when the piezoelectric elements 34 contract upon energization, the diaphragm 33 is bent and warped to one side, leading to a decrease in the volume of each of the pressure chambers C1. As a result, the pressure in the pressure chambers C1 increases, causing ink droplets to be ejected from the nozzles N. Meanwhile, the pressure also propagates from each of the pressure chambers C1 toward the corresponding one of the narrowed portions 312, and the ink also flows into the common channel Rb through the narrowed portions 312. After the ink is ejected, the piezoelectric elements 34 are restored to their original positions. Meanwhile, ink in the flow paths from the respective nozzles N to the common channel Rb is vibrated. Then, ink is fed from the narrowed portions 312 upon the restoration of the menisci of the nozzles N. Ink is ejected from the nozzles N by the above series of actions.

### 1D. Channel Member 5

As mentioned above, the channel member 5 includes the first channel member 51, the second channel member 52, and the projections 54 illustrated in FIG. 3. These members have holes or recesses that constitute a liquid channel. The first channel member 51 and the second channel member 52 are stacked. These members are joined to each other by, for example, an adhesive. The stacking direction of these members is the Z1 direction.

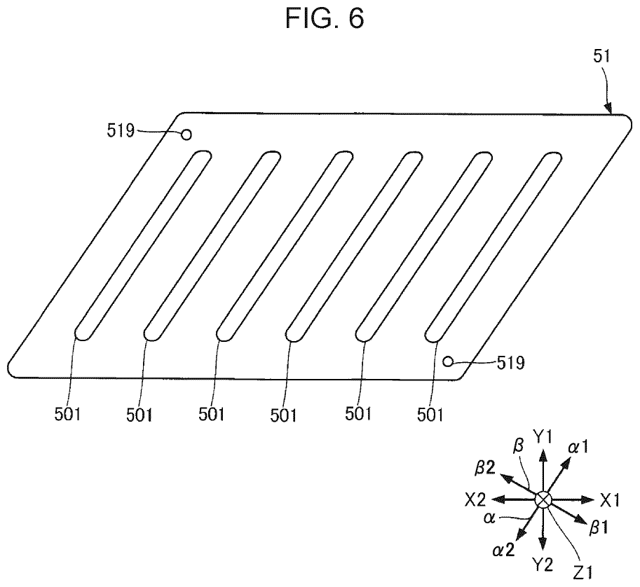

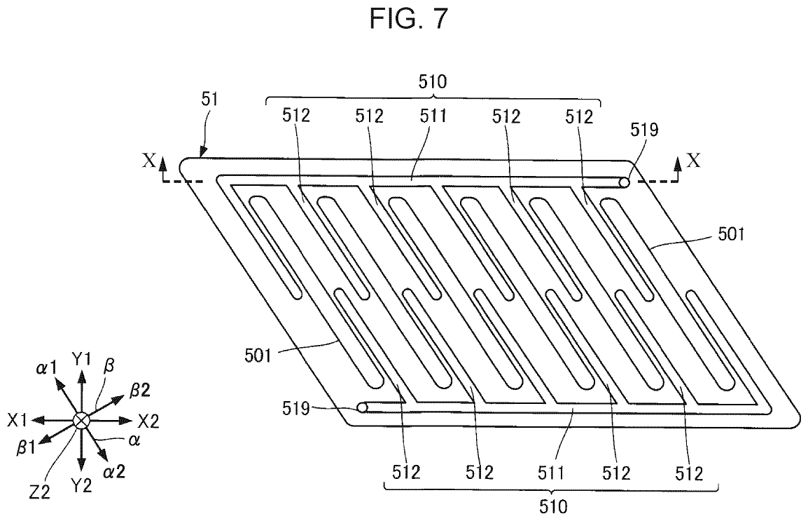

FIG. 6 illustrates the first channel member 51 in FIG. 3 viewed in the Z1 direction. FIG. 7 illustrates the first channel member 51 in FIG. 3 viewed in the Z2 direction. As illustrated in FIGS. 6 and 7, the first channel member 51 has holes 501, each of which is provided for the corresponding one of the head chips 3. Each of the holes 501 is part of the corresponding one of the wiring holes 500.

The first channel member 51 has two through-holes 519. The two through-holes 519 are provided for the two respective projections 54 mentioned above. Each through-hole 519 communicates with the hole 509 in the corresponding projection 54. The first channel member 51 is rectangular in plan view, and the two through-holes 519 are provided in any two of the four corners of the first channel member 51 in plan view. The two through-holes 519 are disposed diagonally opposite to each other in plan view of the first channel member 51.

As illustrated in FIG. 7, two first grooves 510 are provided in a surface on the Z1 side of the first channel member 51. The first grooves 510 are recesses in the first channel member 51. The first grooves 510 each include a first common groove 511 and first branch grooves 512.

The first common groove 511 extends along the X-axis. The two first common grooves 511 are located opposite to each other with the holes 501 therebetween in plan view. The inside of each of the first common grooves 511 communicates with the corresponding one of the through-holes 519. Each of the two first common grooves 511 is shared by the head chips 3. The first branch grooves 512 are coupled to the first common groove 511. The first branch grooves 512 are spaced apart from each other and extend along the α-axis from the first common groove 511. The first branch grooves 512 each extend from the first common groove 511 and passes through the midsection of the first channel member 51 in the Y-axis direction. The first branch grooves 512 each extend to the center line extending along the X-axis of the first channel member 51. The first branch grooves 512 are provided for the respective nozzle rows of the head chips 3.

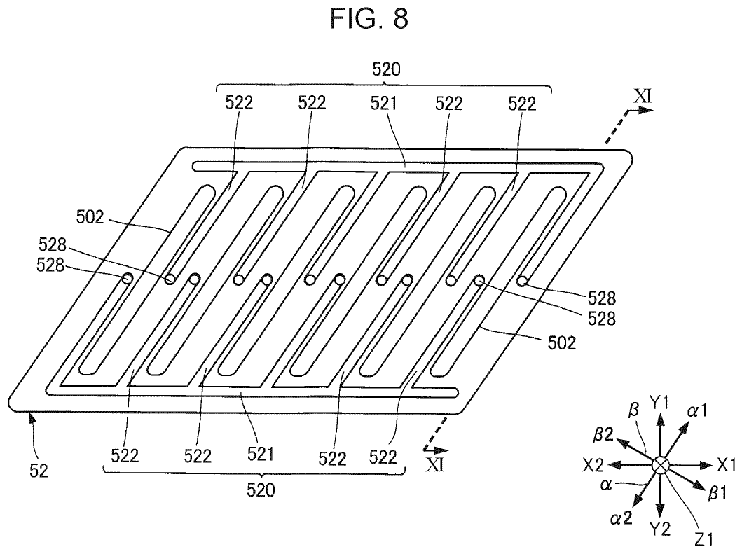

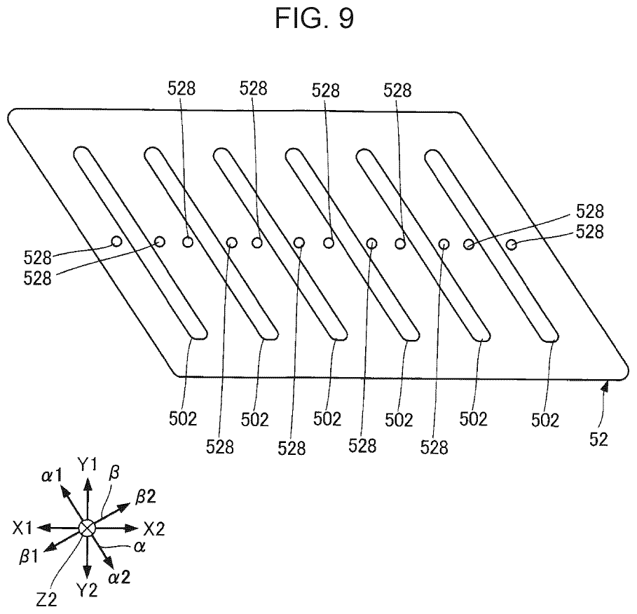

FIG. 8 illustrates the second channel member 52 in FIG. 3 viewed in the Z1 direction. FIG. 9 illustrates the second channel member 52 in FIG. 3 viewed in the Z2 direction. As illustrated in FIGS. 8 and 9, the second channel member 52 has holes 502, each of which is provided for the corresponding one of the head chips 3. Each of the holes 502 is part of the corresponding one of the wiring holes 500.

As illustrated in FIG. 8, two second grooves 520 are provided in a surface on the Z2 side of the second channel member 52. The second grooves 520 are recesses in the second channel member 52. In plan view, the two second grooves 520 overlap the two respective first grooves 510 mentioned above. The shape of the second grooves 520 in plan view is identical to that of the first grooves 510 in plan view. The first channel member 51 and the second channel member 52 are fixed to each other with an adhesive applied to areas around the first grooves 510 and the second grooves 520 facing each other in plan view. The adhesive seals a space between the periphery of the first grooves 510 and the periphery of the second grooves 520 to define a feed channel R1.

Two second common grooves 521 extend along the X-axis. The two second common grooves 521 are located opposite to each other with the holes 502 therebetween in plan view. Each of the two second common grooves 521 is shared by the head chips 3. Second branch grooves 522 are coupled to the second common groove 521. The second branch grooves 522 are spaced apart from each other and extend along the α-axis from the second common groove 521. The second branch grooves 522 each extend from the second common groove 521 and passes through the midsection of the second channel member 52 in the Y-axis direction. The second branch grooves 522 each extend to the center line extending along the X-axis of the second channel member 52. The second branch grooves 522 are provided for the respective nozzle rows of the head chips 3.

The second channel member 52 has through-holes 528. Each of the through-holes 528 is provided for the corresponding one of the second branch grooves 522. The through-holes 528 are provided at the tips of the respective second branch grooves 522. The tip of each of the second branch grooves 522 is opposite to its end coupled to the second common groove 521. In plan view, each through-hole 528 is disposed at a position overlapping the end of the corresponding first branch groove 512 that is opposite to its end coupled to the first common groove 511. Each of the through-holes 528 is provided for the corresponding one of the head chips 3. In plan view, the through-holes 528 overlap through-holes 361 of the respective head chips 3.

### 1E. Liquid Channel of Channel Member 5

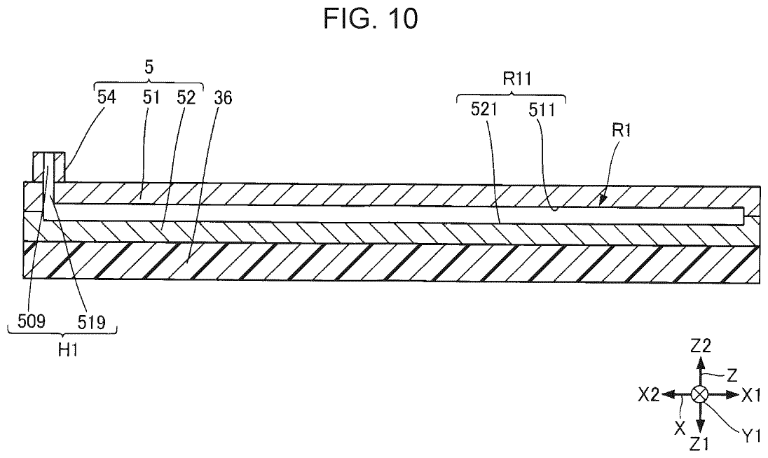

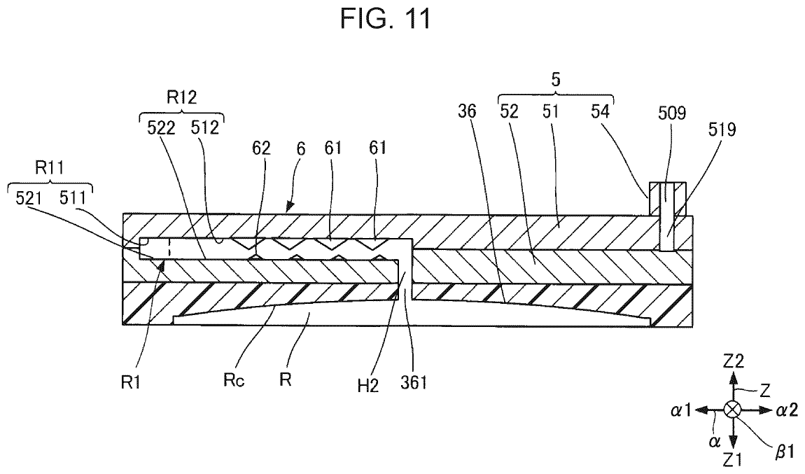

FIGS. 10 and 11 are sectional views of the channel member 5 and the case 36 (see FIG. 2). FIG. 10 corresponds to a section taken along line X-X in FIG. 7. FIG. 11 corresponds to a section taken along line XI-XI in FIG. 8.

As illustrated in FIG. 10 or 11, the channel member 5 includes inlets H1, the feed channel R1, and outlets H2. The inlets H1, the outlets H2, and the feed channel R1 are spaces in the channel member 5 and constitute a liquid channel through which ink flows.

The inlet H1 illustrated in FIG. 10 is a hole provided in the channel member 5 to introduce ink into the channel member 5. The inlet H1 extends along the Z-axis. The inlet H1 is composed of the through-hole 519 and the hole 509 mentioned above. The inlet H1 communicates with the feed channel R1.

The feed channel R1 is a space in the channel member 5. The feed channel R1 includes a common portion R11 (see FIG. 10) and branch portions R12 (see FIG. 11). FIG. 11 is a sectional view of one of the branch portions R12.

The common portion R11 extends in a straight line along the X-axis. The common portion R11 is the space composed of the first common grooves 511 and the second common grooves 521 mentioned above. The common portion R11 intersects the aforementioned nozzle rows in plan view. The common portion R11 communicates with the inlet H1.

The branch portions R12 each branch off from the common portion R11 and each extend in a straight line along the α-axis. Each branch portion R12 is the space composed of the corresponding first branch groove 512 and the corresponding second branch groove 522 mentioned above. The branch portions R12 are each parallel to the aforementioned nozzle rows in plan view. The branch portions R12 communicate with the respective outlets H2.

The outlet H2 illustrated in FIG. 11 is a hole provided in the channel member 5 to feed ink from the channel member 5 into the nozzles N through the through-holes 361 and the common liquid chamber R. The outlet H2 extends along the Z-axis. The outlet H2 is the through-hole 528. The outlet H2 communicates with the through-hole 361.

In the channel member 5, the ink flows through each inlet H1, each common portion R11 of the feed channel R1, each branch portion R12 of the feed channel R1, and each outlet H2 in sequence. In the case 36, the ink flows through each through-hole 361 and then flows through the common liquid chamber R.

### 1F. Stirrer 6

As illustrated in FIG. 11, the feed channel R1 of the channel member 5 is provided with a stirrer 6. The stirrer 6 includes protrusions on a wall surface that defines the feed channel R1. The stirrer 6 is provided to stir ink in the feed channel R1.

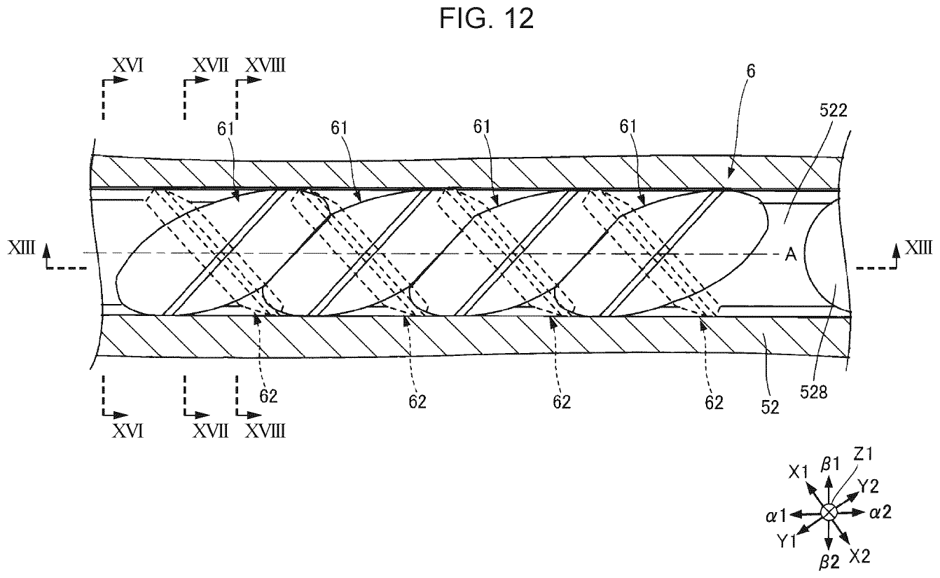

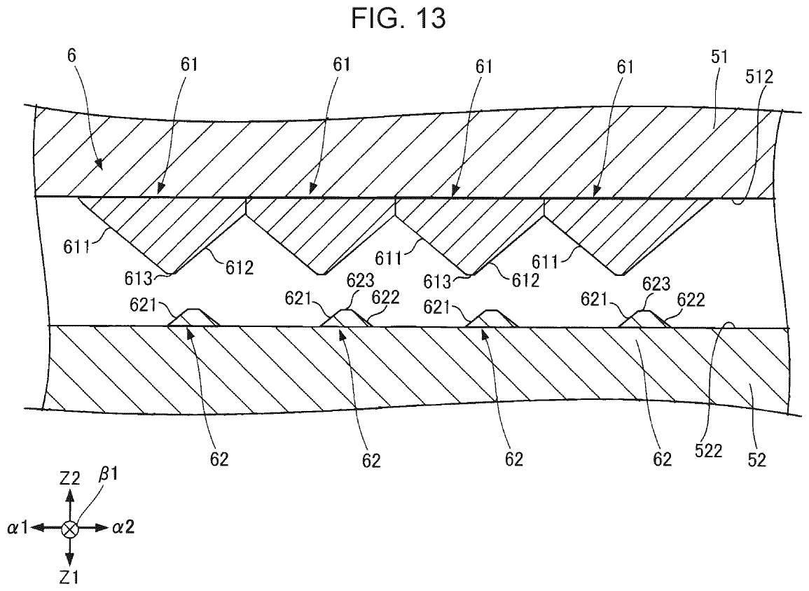

FIG. 12 is a plan view of the stirrer 6 illustrated in FIG. 11. Specifically, FIG. 12 illustrates the second channel member 52 and first ribs 61 viewed in the Z1 direction. The first ribs 61 will be described below. FIG. 13 is a sectional view of the channel member 5 taken along line XIII-XIII in FIG. 12. As illustrated in FIGS. 12 and 13, the stirrer 6 includes the first ribs 61 and second ribs 62. In other words, the stirrer 6 includes pairs of ribs each consisting of one first rib 61 and one second rib 62. The first ribs 61 and the second ribs 62 are disposed to face each other.

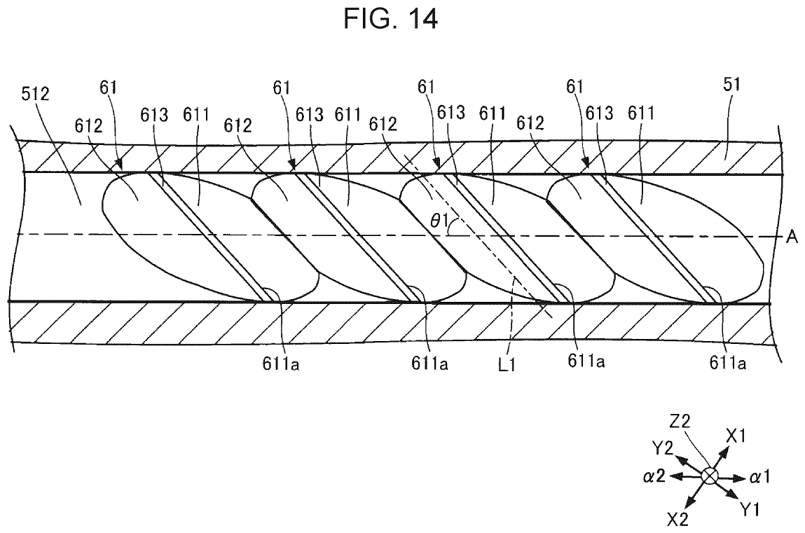

Referring to FIG. 13, each of the first ribs 61 is provided in the first branch groove 512 of the first groove 510, which is a wall surface defining the feed channel R1. Each of the first ribs 61 is a protrusion sticking out of the first branch groove 512 in the Z1 direction. As illustrated in FIG. 14, the first ribs 61 each have a first tip 611a, which intersects an axis A of each of the branch portion R12 of the feed channel R1. The axis A extends in the α2 direction. The α2 direction coincides with the direction in which the stirrer 6 extends.

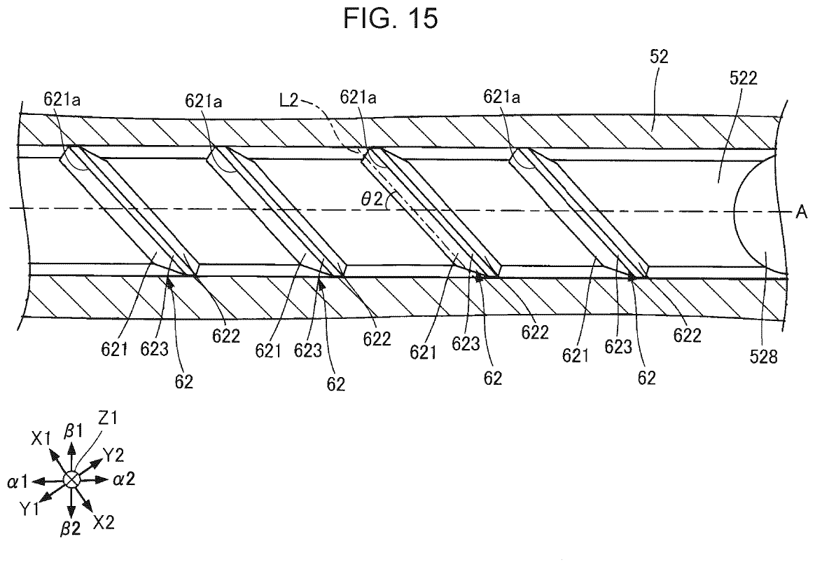

Referring to FIG. 13, each of the second ribs 62 is provided in the second branch groove 522 of the second groove 520, which is a wall surface defining the feed channel R1. Each of the second ribs 62 is a protrusion sticking out of the second branch groove 522 in the Z2 direction. As illustrated in FIG. 15, the second ribs 62 each have a second tip 621a, which intersects the axis A. The first ribs 61 overlap the second ribs 62 in plan view.

The feed channel R1 is provided with the stirrer 6 including the first ribs 61 and the second ribs 62 facing each other so that ink in the feed channel R1 can be stirred. Thus, sedimentation of ink components such as colorants (e.g., dyes or pigments) is less likely to occur in the feed channel R1. This reduces unevenness in the concentration of ink flowing into the common liquid chamber R of each of the head chips 3 through the outlets H2 and the through-holes 361. This eliminates or reduces the possibility that the print quality deteriorates due to the sedimentation of ink components such as colorants.

FIG. 14 is a plan view of the first ribs 61 illustrated in FIG. 12. As illustrated in FIG. 14, the first ribs 61 each have a first guide face 611, a first face 612, and a first tip face 613. The first guide face 611, the first face 612, and the first tip face 613 are flat; however, these faces each may include a curved surface.

The first guide face 611 of each of the first ribs 61 is oriented toward the ink feed side, that is, toward the common portion R11. The line normal to the first guide face 611 intersects the axis A of the branch portion R12. The first face 612 of each of the first ribs 61 is oriented toward the ink discharge side, that is, toward the through-hole 528. The line normal to the first face 612 intersects the axis A of the branch portion R12. The first tip face 613 is located between the first guide face 611 and the first face 612 in plan view. The first tip face 613 is connected to the first guide face 611 and the first face 612. The first tip face 613 is long and extends along an X-Y plane. The line normal to the first tip face 613 is orthogonal to the axis A. The first tip face 613 extends in a direction that intersects the axis A in plan view.

FIG. 15 is a plan view of the second ribs 62 illustrated in FIG. 12. As illustrated in FIG. 15, the second ribs 62 each have a second guide face 621, a second face 622, and a second tip face 623. The second guide face 621, the second face 622, and the second tip face 623 are flat; however, these faces each may include a curved surface. In plan view, each of the second guide faces 621, the second face 622, and the second tip face 623 in the illustrated example is long and extends along an axis intersecting both the α-axis and the β-axis.

The second guide face 621 of each of the second ribs 62 is oriented toward the ink feed side, that is, toward the common portion R11. The line normal to the second guide face 621 intersects the axis A of the branch portion R12. The second face 622 of each of the second ribs 62 is oriented toward the ink discharge side, that is, toward the through-hole 528. The line normal to the second face 622 intersects the axis A of the branch portion R12. The second tip face 623 is located between the second guide face 621 and the second face 622 in plan view. The second tip face 623 is connected to the second guide face 621 and the second face 622. The second tip face 623 extends along an X-Y plane. The line normal to the second tip face 623 is orthogonal to the axis A. The second tip face 623 extends in a direction that intersects the axis A in plan view.

Referring to FIGS. 12, 14, and 15, each second tip face 623 and the corresponding first tip face 613 intersect each other in plan view. The first tip 611a where the first guide face 611 is connected to the first tip face 613 and the second tip 621a where the second guide face 621 is connected to the second tip face 623 intersect each other in plan view. The first tip 611a is the line of intersection of the first guide face 611 and the first tip face 613, and the first tip 611a may also be the line of intersection of the first guide face 611 and a horizontal plane, the line of intersection of the first guide face 611 and a plane orthogonal to the stacking direction of the first channel member 51 and the second channel member 52, or the line of intersection of the first guide face 611 and a plane parallel to a surface of the nozzle substrate 37 in which the nozzles N are provided. Likewise, the second tip 621a is the line of intersection of the second guide face 621 and the second tip face 623, and the second tip 621a may also be the line of intersection of the second guide face 621 and a horizontal plane, the line of intersection of the second guide face 621 and a plane orthogonal to the stacking direction of the first channel member 51 and the second channel member 52, or the line of intersection of the second guide face 621 and a plane parallel to a surface of the nozzle substrate 37 in which the nozzles N are provided. The first tip 611a may be the first tip face 613; that is, the first tip 611a may be the tip portion of the first rib 61 in the Z1 direction in which the first rib 61 protrudes. Likewise, the second tip 621a may be the second tip face 623; that is, the second tip 621a may be the tip portion of the second rib 62 in the Z2 direction in which the second rib 62 protrudes.

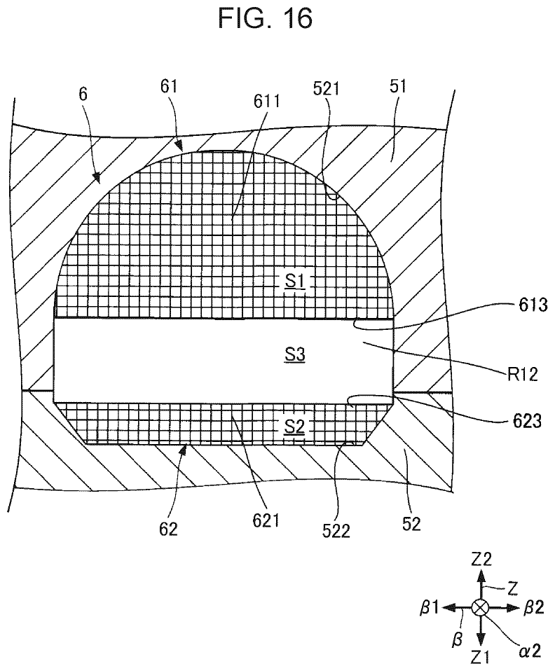

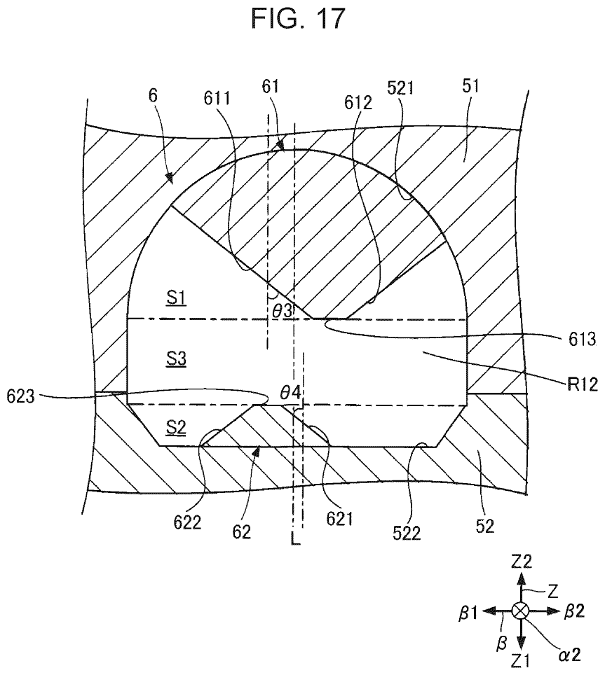

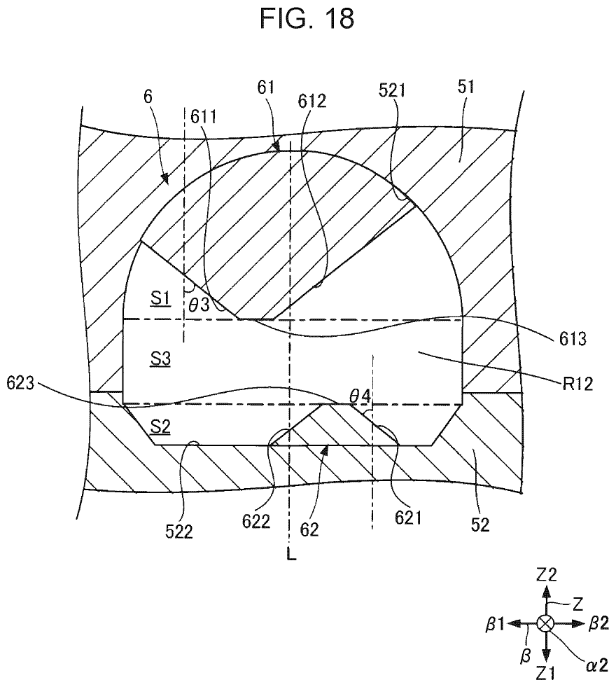

FIG. 16 is a sectional view of the channel member 5 taken along line XVI-XVI in FIG. 12. FIG. 17 is a sectional view of the channel member 5 taken along line XVII-XVII in FIG. 12. FIG. 18 is a sectional view of the channel member 5 taken along line XVIII-XVIII in FIG. 12. FIGS. 16, 17, and 18 illustrate sections perpendicular to the axis A extending in the α2 direction, that is, in the direction in which the stirrer 6 extends. In other words, FIGS. 16, 17, and 18 are cross-sectional views of the branch portion R12. Mesh patterns on the first guide face 611 and the second guide face 621 in FIG. 16 are intended to facilitate the understanding of the arrangement of the guide faces.

Referring to FIGS. 16 to 18, which illustrate cross sections perpendicular to the α2 direction, the branch portions R12 of the feed channel R1 each include a first region S1, a second region S2, and a third region S3. The first region S1, the third region S3, and the second region S2 are arranged in sequence in the Z1 direction. The first region S1 is the area where the first rib 61 is disposed. The second region S2 is the area where the second rib 62 is disposed. The third region S3 is located between the first region S1 and the second region S2 and is a region where neither the first rib 61 nor the second rib 62 is disposed. Thus, the first rib 61 and the second rib 62 are located away from each other.

A flow of ink in the first region S1 is guided into the second region S2 by the first guide face 611 of the first rib 61. A flow of ink in the second region S2 is guided into the first region S1 by the second guide face 621 of the second rib 62. As mentioned above, the first tip 611a and the second tip 621a intersect each other in plan view. In other words, the first tip 611a and the second tip 621a intersect each other when viewed in the Z1 direction, that is, in the direction in which the first region S1 and the second region S2 are aligned.

The stirrer 6 including the first guide faces 611 and the second guide faces 621 arranged as above is provided, in which case the ink can be stirred throughout the stirrer 6. Furthermore, the flow of ink guided by each of the first guide faces 611 and the flow of ink guided by each of the second guide faces 621 are less likely to collide with each other while being stirred. Thus, ink is efficiently stirred throughout the stirrer 6. If ink remains still in the feed channel R1 for a long period of time, sedimentation of the ink components such as colorants may occur in the feed channel R1. In such a case, however, the sediment ink is less likely to be fed into the common liquid chamber R. Accordingly, even if sedimentation of the ink components such as colorants occurs due to the ink being retained for a prolonged period of time without being ejected from the nozzles N, the sediment components can be efficiently stirred once the ink begins to flow. This eliminates or reduces the possibility that the sediment ink is ejected from the nozzles N, and thus reduces the possibility of degradation in image quality. Furthermore, this reduces the need of the cleaning in which ink in the feed channel R1 is discharged to clear the sediment before printing is performed. As a result, unnecessary liquid consumption may be reduced.

As mentioned above, the third region S3 is located between the first rib 61 and the second rib 62. That is, the first rib 61 and the second rib 62 are disposed with a gap therebetween. The influence of the increased channel resistance due to providing the first rib 61 and the second rib 62 is reduced as compared to when there is no gap between the first rib 61 and the second rib 62. In addition, the gap is used to change the flow of ink and ink can thus be stirred more efficiently.

As mentioned above, the first channel member 51 and the second channel member 52 are stacked to constitute the feed channel R1. The first ribs 61 are provided on the first channel member 51, and the second ribs 62 are provided on the second channel member 52. Accordingly, since the first ribs 61 are formed on the first channel member 51 and the second ribs 62 are formed on the second channel member 52, the stirrer 6 having the number of constituent components less than that of a stirrer that is, for example, a static mixer disposed between the channel members may be formed.

The first channel member 51 and the first ribs 61 are preferably formed as one piece by, for example, injection molding; however, the first channel member 51 and the first ribs 61 may be formed as separate members and may then be joined together. Likewise, the second channel member 52 and the second ribs 62 are preferably formed as one piece by, for example, injection molding; however, the second channel member 52 and the second ribs 62 may be formed as separate members and may then be joined together.

The stirrer 6 includes pairs of ribs each consisting of one first rib 61 and one second rib 62. This enables ink to be stirred repeatedly and thus makes it easier to stir ink than if there were only one pair of ribs consisting of one first rib 61 and one second rib 62. Alternatively, the stirrer 6 may include one pair of ribs consisting of one first rib 61 and one second rib 62.

The first ribs 61 are preferably equal in number to the second ribs 62. This enables ink to be stirred efficiently without unnecessary increase in channel resistance, unlike the case in which the first ribs 61 are not equal in number to the second ribs 62. Alternatively, the number of first ribs 61 may be different from the number of second ribs 62.

Referring to FIGS. 17 and 18, L denotes a line segment extending in the direction in which the first region S1 and the second region S2 are aligned. The line segment L is the center line of the branch portion R12 relative to the β-axis direction. In a cross-sectional view, the distance between the line segment L and the first tip face 613 is equal to the distance between the line segment L and the second tip face 623. The same holds true for every cross section of the stirrer 6. It is easier to stir ink evenly throughout the entirety of the stirrer 6 in the feed channel R1 than if the distances were not equal.

A first angle θ1 in FIG. 14 is substantially equal to a second angle θ2 in FIG. 15. The expression “substantially equal” herein means that the angles are exactly the same or a manufacturing or measurement error of less than 1% is introduced. The first angle θ1 in FIG. 14 is the angle formed between L1 and the α2 direction in which the stirrer 6 extends. L1 is the intersection line of the first guide face 611 and a plane perpendicular to the Z1 direction in which the first channel member 51 and the second channel member 52 are stacked. The second angle θ2 in FIG. 15 is the angle formed between L2 and the α2 direction in which the stirrer 6 extends. L2 is the intersection line of the second guide face 621 and a plane perpendicular to the Z1 direction in which the first channel member 51 and the second channel member 52 are stacked.

Ink can be stirred more efficiently throughout the entirety of the stirrer 6 where the first angle θ1 is substantially equal to the second angle θ2 than if the first angle θ1 was not equal to the second angle θ2. This efficiently eliminates or reduces the possibility of sedimentation of the ink components such as colorants. Even in the event of sedimentation, the sediment ink components can be stirred in an efficient manner.

Although the first angle θ1 is not limited to a particular value, the first angle θ1 is preferably in the range of 30 degrees to 60 degrees. Ink can be stirred more efficiently throughout the stirrer 6 where the first angle θ1 is within the range than if the first angle θ1 fell outside the range. In this respect, the first angle θ1 is preferably not less than 35 degrees and not more than 55 degrees and is more preferably not less than 40 degrees and not more than 50 degrees.

Although the second angle θ2 is not limited to a particular value, the second angle θ2 is preferably in the range of 30 degrees to 60 degrees. Ink can be stirred more efficiently throughout the stirrer 6 where the second angle θ2 is within the range than if the second angle θ2 fell outside the range. In this respect, the second angle θ2 is preferably not less than 35 degrees and not more than 55 degrees and is more preferably not less than 40 degrees and not more than 50 degrees.

As illustrated in FIGS. 17 and 18, a third angle θ3 is substantially equal to a fourth angle θ4. The expression “substantially equal” herein means that the angles are exactly the same or a manufacturing or measurement error of less than 1% is introduced. The third angle θ3 is the angle formed between the first guide face 611 and the Z1 direction in which the first channel member 51 and the second channel member 52 are stacked. The fourth angle θ4 is the angle formed between the second guide face 621 and the Z1 direction in which the first channel member 51 and the second channel member 52 are stacked.

Ink can be stirred more efficiently throughout the entirety of the stirrer 6 where the third angle θ3 is substantially equal to the fourth angle θ4 than if the third angle θ3 was not equal to the fourth angle θ4. This efficiently eliminates or reduces the possibility of sedimentation of the ink components such as colorants. Even in the event of sedimentation, the sediment ink components can be stirred in an efficient manner.

Although the third angle θ3 is not limited to a particular value, the third angle θ3 is preferably in the range of 30 degrees to 60 degrees. Ink can be stirred more efficiently throughout the stirrer 6 where the third angle θ3 is within the range than if the third angle θ3 fell outside the range. In this respect, the third angle θ3 is preferably not less than 35 degrees and not more than 55 degrees and is more preferably not less than 40 degrees and not more than 50 degrees.

Although the fourth angle θ4 is not limited to a particular value, the fourth angle θ4 is preferably in the range of 30 degrees to 60 degrees. Ink can be stirred more efficiently throughout the stirrer 6 where the fourth angle θ4 is within the range than if the fourth angle θ4 fell outside the range. In this respect, the fourth angle θ4 is preferably not less than 35 degrees and not more than 55 degrees and is more preferably not less than 40 degrees and not more than 50 degrees.

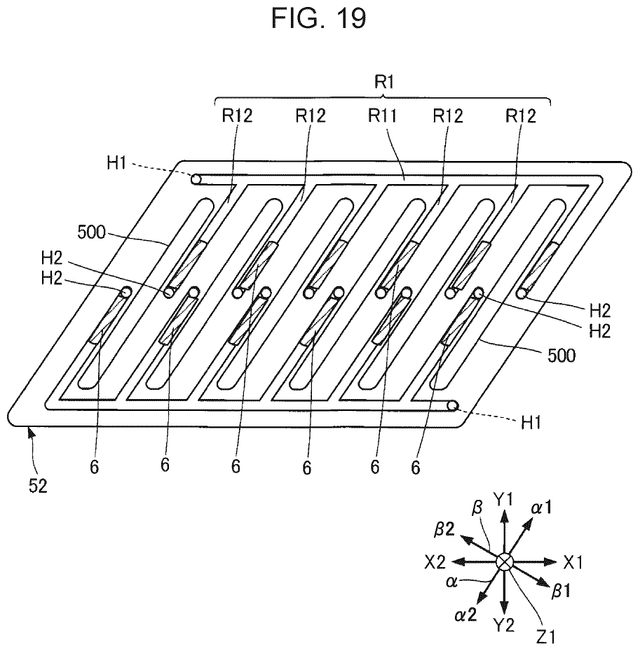

FIG. 19 is an explanatory diagram illustrating the arrangement of stirrers 6 illustrated in FIG. 12. As illustrated in FIG. 19, each of the stirrers 6 is provided for the corresponding one of the branch portions R12 of the feed channel R1. Providing the stirrers 6 in the respective branch portions R12 instead of providing them in the common portion R11 enables an increase in the amount of ink that can recover from sedimentation in the feed channel R1, without adding much extra channel resistance. Alternatively, the stirrer 6 may be provided in the common portion R11.

The stirrers 6 are each closer to the outlet H2 than to the inlet H1. Unlike the stirrers 6 being closer to the inlet H1 than to the outlet H2, the stirrers 6 arranged as above help increase the amount of ink that can recover from sedimentation in the feed channel R1, without adding much extra channel resistance. Each of the stirrers 6 preferably extends from the corresponding one of the outlets H2 and is preferably located within the range of 20% of the flow path extending from the outlet H2 to the inlet H1. Alternatively, the stirrers 6 may each be closer to the inlet H1 than to the outlet H2. Still alternatively, the stirrer 6 may extend all along the feed channel R1.

Each of the stirrers 6 is located in a linear section of the corresponding one of the branch portions R12 of the feed channel R1. In other words, the stirrers 6 are not provided in bent sections of the feed channel R1. The bent sections are sections where the branch portions R12 are coupled to the common portion R11. Providing the stirrers 6 in the respective linear sections is advantageous in that it is easier to stir ink than if the stirrers 6 were located in the respective bent sections. Alternatively, the stirrers 6 may be provided in the bent sections.

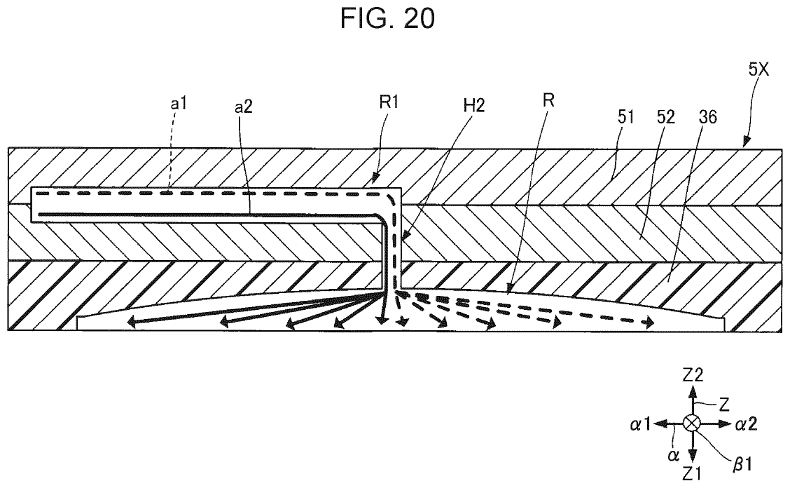

FIG. 20 is an explanatory diagram illustrating the flow of ink in a channel of a channel member 5X in Comparative Example. The channel member 5X in Comparative Example illustrated in FIG. 20 is not provided with the stirrers 6.

With regard to Comparative Example illustrated in FIG. 20, the following describes a case in which ink begins to flow after being retained for a prolonged period of time during which the ink is not ejected from the nozzles N and sedimentation of ink components such as colorants have occurred. In this case, it is difficult to stir the ink in the feed channel R1 because the channel member 5X in Comparative Example is not provided with the stirrers 6.

As indicated by a dotted arrow a1, low-concentration ink in which colorants and the like are contained in low concentrations flows through the Z2 side of the feed channel R1. As indicated by a solid arrow a2, high-concentration ink in which colorants and the like are contained in high concentrations flows through the Z1 side of the feed channel R1. The low-concentration ink and the high-concentration ink without being stirred flow into the common liquid chamber R through the outlets H2. Thus, the low-concentration ink and the high-concentration ink flow through the respective regions within the common liquid chamber R. Consequently, unevenness in the concentration of ink is developed within the common liquid chamber R of each head chip 3. This results in deterioration in image quality, such as color irregularities.

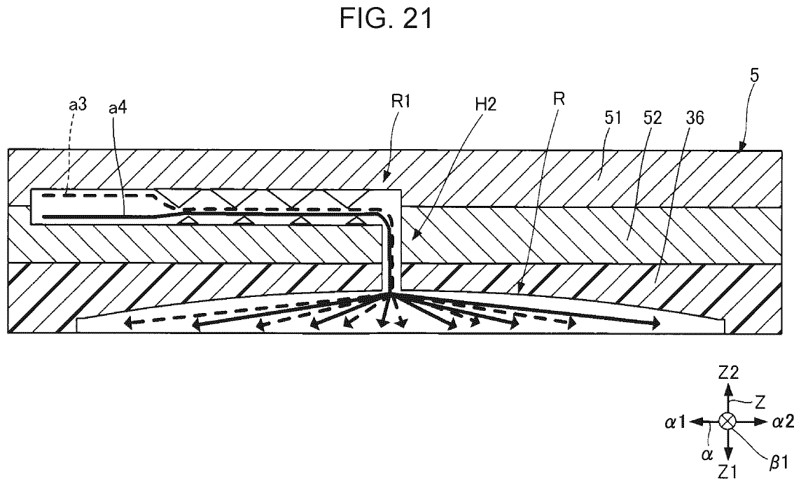

FIG. 21 is an explanatory diagram illustrating the flow of ink in the liquid channel of the channel member 5 in the first embodiment. As illustrated in FIG. 21, the channel member 5 in the present embodiment are provided with the stirrers 6.

With regard to the present embodiment illustrated in FIG. 21, the following describes a case in which ink begins to flow after being retained for a prolonged period of time during which the ink is not ejected from the nozzles N and sedimentation of ink components such as colorants have occurred. The stirrers 6 are provided in the channel member 5 in the present embodiment and the ink is more likely to be stirred in the feed channel R1.

As indicated by a dotted arrow a3, low-concentration ink in which colorants and the like are contained in low concentrations flows through the feed channel R1. As indicated by a solid arrow a4, high-concentration ink in which colorants and the like are contained in high concentrations flows through the feed channel R1. The low-concentration ink and the high-concentration ink are mixed at the stirrer 6. While being mixed, the low-concentration ink and the high-concentration ink flow into the common liquid chamber R through the outlets H2. This means that the low-concentration ink and the high-concentration ink within the common liquid chamber R are in a mixed state. This eliminates or reduces the possibility of unevenness in the concentration of ink within the common liquid chamber R of each head chip 3. The possibility of deterioration in image quality, such as color irregularities, is reduced accordingly.

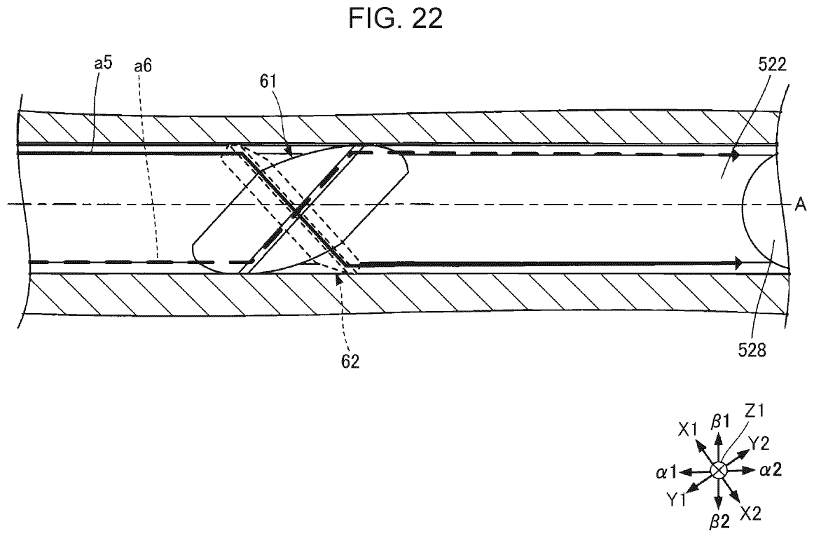

FIG. 22 is an explanatory diagram illustrating the flow of ink along the first ribs 61 and the second ribs 62 of the stirrer 6 in FIG. 11. For the sake of simplicity, one pair of ribs consisting of one first rib 61 and one second rib 62 is illustrated in FIG. 22. The flow of low-concentration ink is, for example, as follows. As indicated by a dotted arrow a6, the low-concentration ink hits the first guide face 611 of the first rib 61 and flows along the first guide face 611. While flowing in the α2 direction, the low-concentration ink is gradually guided in the β1 direction and the Z1 direction and then flows into the outlet H2.

The flow of high-concentration ink is, for example, as follows. As indicated by a solid arrow a5, the high-concentration ink hits the second guide face 621 of the second rib 62 and flows along the second guide face 621. While flowing in the α2 direction, the low-concentration ink is gradually guided in the β2 direction and the Z2 direction and then flows into the outlet H2.

The ink is stirred while these flows of ink are generated for each pair of ribs consisting of one first rib 61 and one second rib 62. The stirrer 6 makes it easier to stir ink especially in the direction perpendicular to the axis A in the X-Y plane.

Ink can be efficiently stirred with the stirrer 6 described above, and the possibility of deterioration in image quality is reduced accordingly.

### 2. Second Embodiment

A second embodiment of the present disclosure is described below. In the embodiment described below, each element whose effects or functions are the same as those of the corresponding element in the first embodiment is denoted by the reference sign used in relation to the first embodiment, and detailed description of such elements is omitted where appropriate.

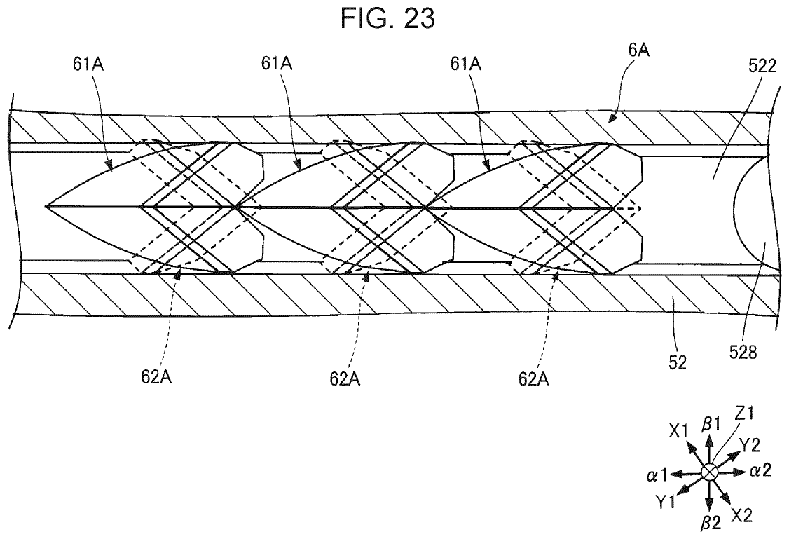

FIG. 23 is a plan view of a stirrer 6A in the second embodiment. As illustrated in FIG. 23, the stirrer 6A includes first ribs 61A and second ribs 62A. In other words, the stirrer 6A includes pairs of ribs each consisting of one first rib 61A and one second rib 62A. The first ribs 61A and the second ribs 62A are disposed to face each other.

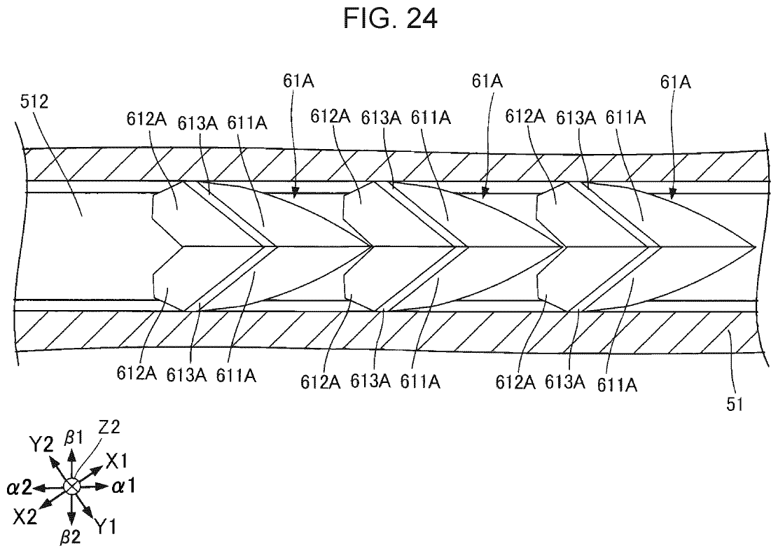

FIG. 24 is a plan view of the first ribs 61A illustrated in FIG. 23. As illustrated in FIG. 24, each of the first ribs 61A is symmetric about the axis A, which is the center line of the structure of the first ribs 61A. The first ribs 61A each have two first guide faces 611A, two first faces 612A, and two first tip faces 613A. These faces are flat. The two first guide faces 611A of each of the first ribs 61A are connected to each other with no gap therebetween. The two first faces 612A of each of the first ribs 61A are connected to each other with no gap therebetween. The two first tip faces 613A of each of the first ribs 61A are connected to each other with no gap therebetween.

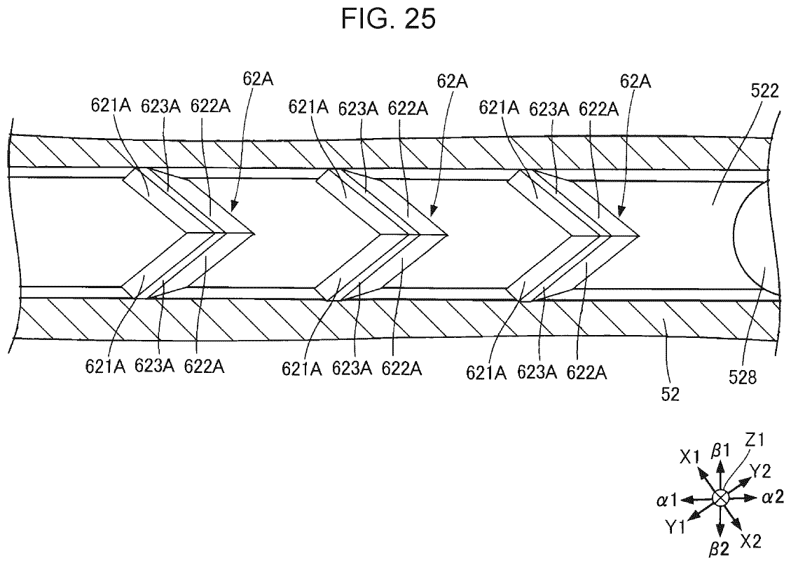

FIG. 25 is a plan view of the second ribs 62A illustrated in FIG. 23. As illustrated in FIG. 25, each of the second ribs 62A is symmetric about the axis A, which is the center line of the structure of the second ribs 62A. The second ribs 62A each have two second guide faces 621A, two second faces 622A, and two second tip faces 623A. These faces are flat. The two second guide faces 621A of each of the second ribs 62A are connected to each other with no gap therebetween. The two second faces 622A of each of the second ribs 62A are connected to each other with no gap therebetween. The two second tip faces 623A of each of the second ribs 62A are connected to each other with no gap therebetween.

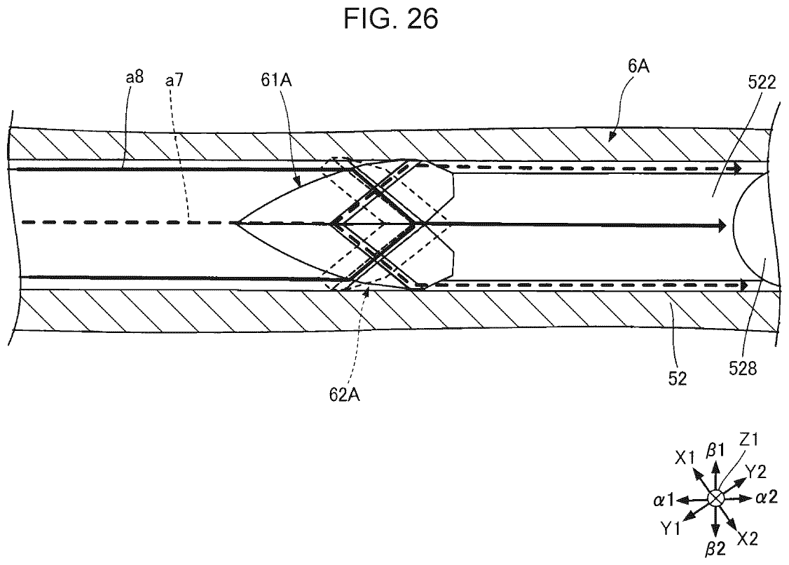

FIG. 26 is an explanatory diagram illustrating the flow of ink along the first ribs 61A and the second ribs 62A of the stirrer 6A illustrated in FIG. 23. For the sake of simplicity, one pair of ribs consisting of one first rib 61A and one second rib 62A is illustrated in FIG. 26. The flow of low-concentration ink is, for example, as follows. As indicated by a dotted arrow a7, the low-concentration ink hits the two first guide faces 611A of the first rib 61A and flows along the first guide faces 611A. Part of the low-concentration ink is gradually guided in the β1 direction and the Z2 direction while flowing in the α2 direction, whereas the rest of the low-concentration ink is gradually guided in the β2 direction and the Z2 direction while flowing in the α2 direction. The low-concentration ink then flows into the outlet H2.

The flow of high-concentration ink is, for example, as follows. As indicated by a solid arrow a8, the high-concentration ink hits the second guide faces 621A of the second rib 62A and flows along the second guide faces 621A. Part of the high-concentration ink is gradually guided in the β2 direction and the Z1 direction while flowing in the β2 direction, whereas the rest of the high-concentration ink is gradually guided in the β1 direction and the Z1 direction while flowing in the α2 direction. The high-concentration ink then flows into the outlet H2.

The ink is stirred while these flows of ink are generated for each pair of ribs consisting of one first rib 61A and one second rib 62A. The stirrer 6A makes it easier to stir ink especially in the direction of the Z-axis.

The present embodiment can produce effects similar to those produced by the first embodiment; that is, ink can be efficiently stirred with the stirrer 6A, and the possibility of deterioration in image quality is reduced accordingly.

### 3. Variations

A wide range of variations of the embodiments described above may be offered. Specific examples of the variations that may be adopted into each of the embodiments are described below. Any two or more of the following examples may be implemented in combination as appropriate unless they are not mutually contradictory.

In each of the embodiments described above, the first ribs are identical in shape, and the second ribs are identical in shape. However, it is not required that the first ribs be identical in shape. Likewise, it is not required that the second ribs be identical in shape.

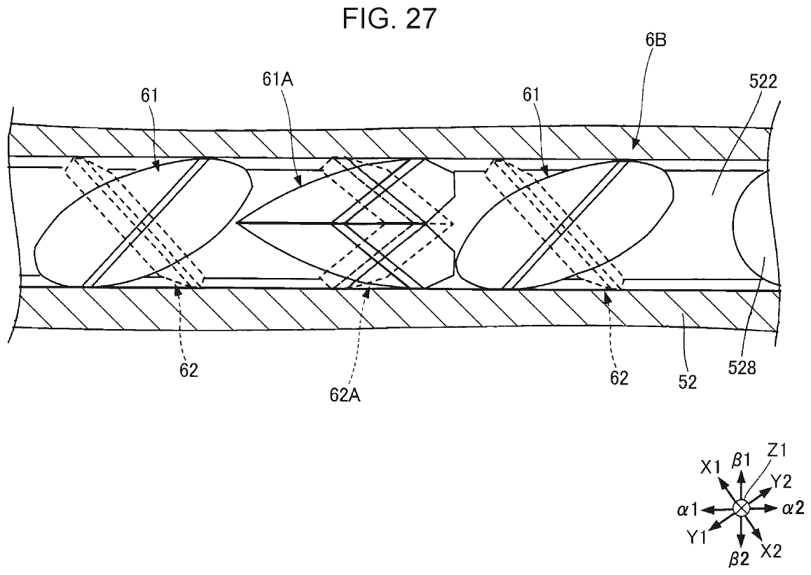

FIG. 27 is a plan view of a stirrer 6B in an example of the variations. Referring to FIG. 27, the stirrer 6B includes pairs of ribs each consisting of one first rib 61 and one second rib 62 and pairs of ribs each consisting of one first rib 61A and one second rib 62A. The pairs of ribs each consisting of one first rib 61 and one second rib 62 alternate with the pairs of ribs each consisting of one first rib 61A and one second rib 62A. The stirrer 6B illustrated in FIG. 27 makes it easier to stir ink both in the direction perpendicular to the axis A in the X-Y plane and in the direction of the Z-axis. Thus, ink can be stirred more efficiently.

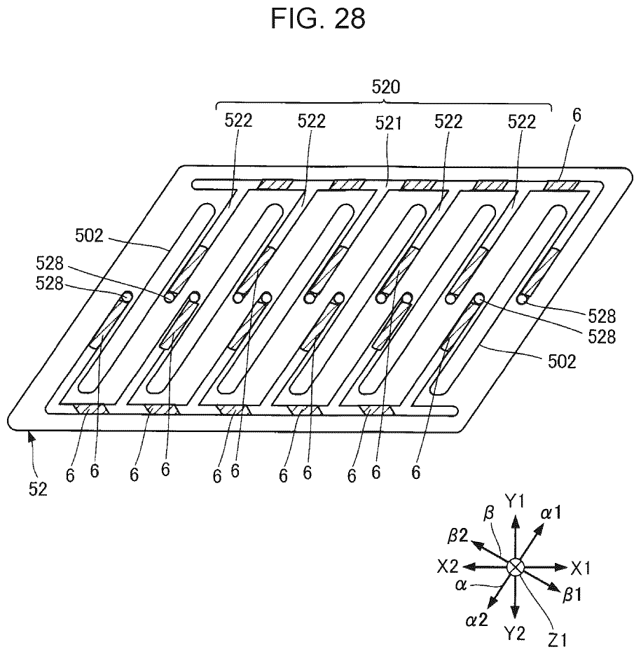

FIG. 28 illustrates the arrangement of the stirrers 6 in an example of the variations. As illustrated in FIG. 28, the stirrers 6 may include those provided in the common portions R11 of the feed channel R1 as well as those provided in the branch portions R12 of the feed channel R1.

The structure of the head chips 3 does not allow ink to circulate through the head chips 3. Alternatively, the head chips 3 may each be a circulation head including circulation channels.

The liquid ejecting apparatus disclosed herein may be adopted into equipment specifically designed for printing and may also be adopted into various machines, such as fax machines and copiers. Uses of the liquid ejecting apparatus are not limited to printing. An example of the liquid ejecting apparatus is capable of ejecting solutions of colorants, in which case the liquid ejecting apparatus concerned may be used to manufacture color filters for liquid crystal display panels and other display units.

Another example of the liquid ejecting apparatus is capable of ejecting solutions of conductive materials, in which case the liquid ejecting apparatus concerned may be used to form wiring and electrodes on circuit boards. Still another example of the liquid ejecting apparatus is capable of ejecting solutions of biological organic substances, in which case the liquid ejecting apparatus concerned may be used to produce biochips or the like.

The present disclosure has been described based on preferred embodiments but is not limited to the embodiments. Each constituent component described herein may be replaced with any element capable of performing the same functions mentioned above in relation to the embodiments or may be supplemented with any such element.

What is claimed is:

1. A liquid ejecting head comprising:
nozzles configured to eject liquid; and
a feed channel through which at least one inlet for introducing the liquid communicates with at least one outlet for feeding the liquid into the nozzles; wherein
the feed channel is provided with at least one stirrer including at least one first rib and at least one second rib facing each other,
the at least one stirrer in a cross section perpendicular to a direction in which the at least one stirrer extends includes a first region in which the at least one first rib is disposed and a second region in which the at least one second rib is disposed,
the at least one first rib has a first guide face by which a flow of the liquid in the first region is guided into the second region,
the at least one second rib has a second guide face by which a flow of the liquid in the second region is guided into the first region, and
a first tip of the first guide face and a second tip of the second guide face intersect each other when viewed in a direction in which the first region and the second region are aligned.

2. The liquid ejecting head according to claim 1, wherein the at least one first rib and the at least one second rib are disposed with a gap in between.

3. The liquid ejecting head according to claim 1, further comprising a first channel member and a second channel member stacked in a stacking direction to constitute the feed channel, wherein
the at least one first rib is provided on the first channel member, and
the at least one second rib is provided on the second channel member.

4. The liquid ejecting head according to claim 1, wherein
the at least one outlet comprises a plurality of outlets,
the at least one stirrer comprises stirrers,
the feed channel includes a common portion coupled to the at least one inlet and branch portions each of which branches off from the common portion and is coupled to a corresponding one of the outlets, and
each of the stirrers is provided for a corresponding one of the branch portions.

5. The liquid ejecting head according to claim 1, wherein the at least one stirrer is closer to the at least one outlet than to the at least one inlet.

6. The liquid ejecting head according to claim 1, wherein the at least one stirrer includes pairs of ribs each consisting of the first rib and the second rib.

7. The liquid ejecting head according to claim 1, wherein
the at least one first rib of the at least one stirrer comprises first ribs,
the at least one second rib of the at least one stirrer comprises second ribs, and
the first ribs are equal in number to the second ribs.

8. The liquid ejecting head according to claim 3, wherein a first angle is substantially equal to a second angle, the first angle being formed between the direction in which the at least one stirrer extends and an intersection line of the first guide face and a plane perpendicular to the stacking direction, the second angle being formed between the direction in which the at least one stirrer extends and an intersection line of the second guide face and the plane perpendicular to the stacking direction.

9. The liquid ejecting head according to claim 8, wherein the first angle is in a range of 30 degrees to 60 degrees.

10. The liquid ejecting head according to claim 3, wherein a third angle is substantially equal to a fourth angle, the third angle being formed between the first guide face and the stacking direction, the fourth angle being formed between the second guide face and the stacking direction.

11. The liquid ejecting head according to claim 10, wherein the third angle is in a range of 30 degrees to 60 degrees.

12. The liquid ejecting head according to claim 1, wherein
the feed channel includes a linear section and a bent section, and
the at least one stirrer is located in the linear section.

13. A liquid ejecting apparatus comprising:
the liquid ejecting head according to claim 1; and
a liquid reservoir in which liquid that is to be fed into the liquid ejecting head is stored.
